(19) United States
(12) Patent Application Publication
(10) Pub. No.: US 2026/0178670 A1
(43) Pub. Date: Jun. 25, 2026

(54) ENHANCED INQUIRY SUPPORT SYSTEMS

(71) Applicant: Blustream Corporation, Worcester, MA (US)

(72) Inventors: William Boute, Bellingham, MA (US); Kenneth N. Rapp, Sutton, MA (US); James Michael Gordon, JR., Worcester, MA (US); Michael Dominick Audi, Worcester, MA (US); Damien Steiger, Worcester, MA (US)

(21) Appl. No.: 19/126,947

(22) PCT Filed: Nov. 1, 2023
(86) PCT No.: PCT/US2023/078383

§ 371 Date: May 2, 2025

Related U.S. Application Data
(60) Provisional application No. 63/421,821, filed on Nov. 2, 2022.

(51) Int. Cl. G06F 16/951; G06F 16/3332; G06F 16/9538

(52) U.S. Cl. CPC G06F 16/951; G06F 16/3338; G06F 16/9538

(57) ABSTRACT

A method includes receiving a first set of data characterizing a basic search query associated with a target object. The method further includes determining, based on the basic search query, a target database for collecting a second set of data associated to an objective of the basic search query. The method further includes receiving the second set of data characterizing the determined objective. The method further includes computing, based on the second set of data, an advanced search query associated with the target object and the determined objective. The method further includes providing the advanced search query.

### RELATED APPLICATION

This application claims priority under 35 U.S.C. § 119(e) to U.S. Provisional Patent Application No. 63/421,821 filed on Nov. 2, 2022, the entire contents of which is hereby expressly incorporated by reference herein.

### TECHNICAL FIELD

The subject matter described herein relates to the use of previously recorded information related to the product that an individual uses to enhance a simple inquiry made by the individual about the product.

### BACKGROUND

Product support is an important function for both the suppliers of products and the customers who use them. There are many systems that have been developed in this arena such as: telephone support staff manning phone banks; online access systems to frequently asked questions; computer-based inquiry systems accessing expert systems, general web pages, community support or automated chat robots; and we expect further development of new artificial intelligence-based systems to evolve. The success of these systems in supplying a valid response depends on the completeness of the information contained in the original inquiry.

### SUMMARY

In an aspect, a method includes receiving a first set of data characterizing a basic search query associated with a target object. The method further includes determining, based on the basic search query, a target database for collecting a second set of data associated to an objective of the basic search query. The method further includes receiving the second set of data characterizing the determined objective. The method further includes computing, based on the second set of data, an advanced search query associated with the target object and the determined objective. The method further includes providing the advanced search query.

One or more of the following features can be included in any feasible combination. For example, the method can include determining one or more characteristic of the advanced search query. The method can include providing the determined one or more characteristics of the advanced search query. The second data set can include at least one of a user preference or a status of the target object.

In an aspect, a system can comprise at least one data processor and a memory storing instructions, which when executed by the at least one data processor, causes the at least one data processor to perform operations comprising receiving a first set of data characterizing a basic search query associated with a target object. The method further includes determining, based on the basic search query, a target database for collecting a second set of data associated to an objective of the basic search query. The method further includes receiving the second set of data characterizing the determined objective. The method further includes computing, based on the second set of data, an advanced search query associated with the target object and the determined objective. The method further includes providing the advanced search query.

One or more of the following features can be included in any feasible combination. For example, the method can include determining one or more characteristic of the advanced search query. The method can include providing the determined one or more characteristics of the advanced search query. The second data set can include at least one of a user preference or a status of the target object.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, and the like.

In an aspect, a non-transitory computer program product storing instructions, which when executed by at least one data processor of at least one computing system, implements a method comprising receiving a first set of data characterizing a basic search query associated with a target object. The method further includes determining, based on the basic search query, a target database for collecting a second set of data associated to an objective of the basic search query. The method further includes receiving the second set of data characterizing the determined objective. The method further includes computing, based on the second set of data, an advanced search query associated with the target object and the determined objective. The method further includes providing the advanced search query.

One or more of the following features can be included in any feasible combination. For example, the method can include determining one or more characteristic of the advanced search query. The method can include providing the determined one or more characteristics of the advanced search query. The second data set can include at least one of a user preference or a status of the target object.

### DESCRIPTION OF DRAWINGS

FIG. 1 is a flow chart of an exemplary method for providing an advanced search query to a user based on the determined objective of a basic search query;

FIG. 2 illustrates an exemplary object query system configured to monitor multiple target objects;

FIG. 3 illustrates an exemplary server associated with the system of FIG. 2;

FIG. 4 illustrates an exemplary channel engine associated with the server of FIG. 3;

FIG. 5 illustrates an exemplary rules engine associated with the server of FIG. 3;

FIG. 6 illustrates an exemplary data processing engine associated with the server of FIG. 3; and

FIG. 7 illustrates an exemplary support engine associated with the server of FIG. 3.

Like reference symbols in the various drawings indicate like elements.

### DETAILED DESCRIPTION

In the usual situation where an individual is seeking new information about the product they are using, the inquiry language includes only the broadest description of the product involved. When the inquiry is submitted to a system that will respond with additional information, the resulting response is often limited to a correspondingly broad answer. By analyzing the broad description of the inquiry and adding to it some appropriate details from the store of previously recorded information before submitting the inquiry, the resulting response is significantly improved.

Some of these systems such as a web browser search or a community support board respond to an inquiry with a list of possible items for the individual to review. The individual then must review these items and decide which ones are likely to be helpful to review further. This process is often a “hit or miss” proposition and can lead the individual down a series of dead ends before finding the sought-after information.

Another type of system can engage the individual in a dialogue by replying with a question. The objective of these systems is to gain better understanding of the inquiry and may respond with successive questions. The basis of the question(s) is any information that is stored in the system pertinent to the general properties of the product being supported. The question-and-answer sequence may lead to a more complete response to the original inquiry, but often at the expense of a tedious dialogue from the perspective of the individual.

When a product support system that contains previously collected information about a product or products that an individual owns is available an improved version of the unsolicited query response is created. This improvement processes the query that contains a general reference to the product of interest and adds specific information available in the product support system.

One example of such a query is “What diet is best for my dog?” In a web browser search a plethora of answers will be presented for the individual to sort though. In a question-and-answer system follow on questions would be presented to the individual. In the improved product support system specific product information such as the breed, age, weight, exercise regimen will be incorporated into the query before submitting it to any other system. By doing so the first resulting response is significantly tailored to the product of interest saving the individual time and potential confusion.

Another example of a product is a musical instrument. There are often special care items such as replacing strings or reeds, cleaning, and polishing, adjusting the mechanical configuration and ensuring the proper environmental conditions for storage. When an individual submits a query such as “Where is the best shop to service my guitar?”, adding additional details from the product support system such as the make, model, age and typical play hours before submitting the query to a general system will result in a more targeted response.

One objective of this invention is to provide an improved experience for an individual seeking additional information for their product from any one of a multitude of repositories. Using data collected in previous conversations with the user, appropriate product detail is added to the ad-hoc query resulting in improved focus of the response. The individual benefits by spending less time and is exposed to less inappropriate or potentially confusing information.

Existing systems will typically engage the user in additional dialogue to add information to the query or leave it up to the user to add additional information in a subsequent query after reviewing a plethora of possible responses generated from the original query. This is often a frustrating and sometimes fruitless experience.

The present invention is supported by the system having a previous relationship with the user in which user and product specific information has been gained about the product(s) the user enjoys. This information is combined with the original user query to create an enhanced query that is submitted to the system originally targeted by the user and optionally to other data systems as well.

The user is not specifically asked to enter additional information. All available user and product information available in the support system is added to the query. This enhanced query results in a more specific response that is more likely to fulfill the reason for entering the query leading to greater user satisfaction and success in the use of their product(s).

Information queries are routinely used by individuals to gain knowledge about products they use or own. There are presently many options for submitting general queries on and ad-hoc basis and the possibilities are ever growing (e.g., Google Search, Bing, answerbase, manufacturer websites, government websites). To use these systems effectively the query should contain as much detail information as possible to narrow the range of results provided by the selected search system. But preparing a comprehensive query is not a natural behavior of the individual seeking the information. For users of a product support system the query can be first supplemented with additional detail present in the product support system before the query is submitted to a general response system.

The system is configured to support products that the user already possesses and is seeking support or additional information for it. In an aspect, the system could be configured to include additional products that are tagged as interest vs. owned. It should be noted that the original query does need to be associated with a product registered with the user. This provides the context for supplying the additional information.

One component of the system is a data storage facility which stores the following categories of data:
a) User information: Information about the user:
b) Product information: Information about the product
c) Usage information: Information about the user's use of the product
d) User-Product information: Information specific to this product and user combined.
e) Environment information: Information about the environment in various geographies
f) Community information: Information about the communities of other users of the product
   Examples of these information categories are:
User information: name, age, address, phone number, email address, lifestyle choices;
Product information: make, model, serial number, breed,
Usage information: hours used, cycles performed, days or months owned, exercise time;
User-Product information: name of pet;
Environmental information: temperature, humidity, precipitation forecast, storm warnings; and
Community information: product clubs, online product user pages, forums, blogs.

Each of the above information categories can have one or more sources. An example of one source can be specific messages that request information form the user that only the user is likely to be able to provide. Typically, this is the user's information. Another source can be the supplier of the product(s), where the supplier enters product specific information using the system interface set up for suppliers. Even another source can be where the system is configured to periodically query external data sources for gain current information about the environment, community activities, news events, etc. These are systems such as the National Weather Service, news outlets, community bulletin boards, social media, professional websites, etc.

Another component of the system is a communication medium that provides personal one on one messaging to individual users. Many technologies such as text messaging, email, voice communication and other means that may be available can be used. These communications can be the source of the user and user-product information described. In an aspect, a user can have previously been engaged by the system for product support so the additional information about the user and the users product is already in the system before the new query is entered. Only a simple reference to one of the users registered products is required for establishing the context of the new query. This enables the additional information to be incorporated without additional prompting to the user.

Another component of the system is a means for the individual user to submit a general query which seeks to return additional information about the product used or owned by the individual. The general query is received by the product support system but is intended to be submitted to an external information retrieval system. In an aspect, the user may specify the target system that the query is directed at. In another instance the system may select one or more target systems to submit the enhanced query to.

Another component of the system is a means to identify the product in the general query and supplement the query with specific detail contained in the product support system. The result is an enhanced detail query. An example of identifying the product can include a user logging into the product support system by way of their user interface. A selection of the users registered products can be available for support. Once the user selects the product of interest for the session, then all subsequent interactions have the context of the selected product. The user may engage in pre-programmed support experiences as covered in other life-cycle support applications, or initiate a general query for additional information that is submitted to one or more external systems. The submitted query will be the enhanced query of this application.

Another component of the system is a means to submit the enhanced detail query to one or more selected external information retrieval systems.

Another component of the system is a means to return the results of the external information retrieval systems to the individual who submitted the original query. The returned results are the results of the external system. Formatting, appearance and the identity of the source are preserved. The value of this system is to significantly reduce the number of entries in the results list that are not relevant to the original query and product. Also the results will most likely contain items that would not otherwise appear in response to the original query only.

The quality and appropriateness of the result list is improved and the amount of irrelevant items is reduced.

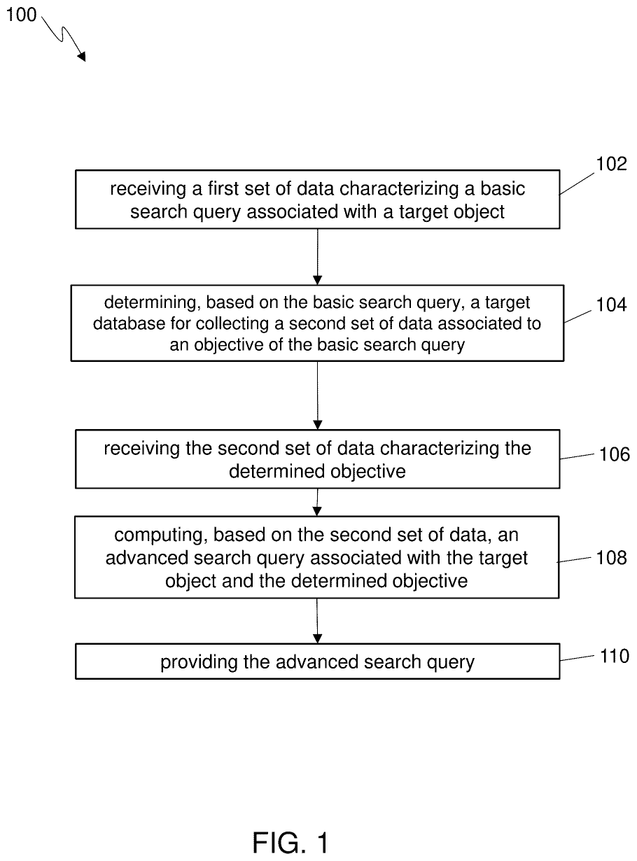

FIG. 1 is a flow chart of an exemplary method for generating an advanced search query based on the determined objective of a basic search query. At 102, data characterizing a basic search query associated with a target object is received and an output data set relating to the basic search query is generated. The data can be received, for example, by a platform (or a server) of a query system.

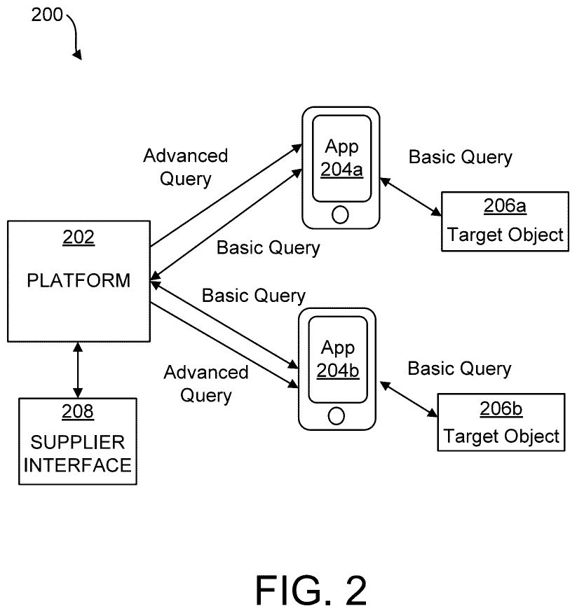

Various components of the query system can be distributed over a cloud, operating devices of users of multiple target objects, locations of the target object. For example, FIG. 2 illustrates an exemplary query system 200 that includes a platform 202; applications 204a and 204b; and a database 208.

The query system 200 can monitor and provide output data sets based on a basic search query inputted by a user. The application 204a (or 204b) can be installed on a computing device (e.g., laptop, mobile device, and the like) of the user of the target object 206a (or 206b). The application can curate the received data and/or transmit the data to the platform 202 in the form of a basic search query.

The platform 202 can receive the data from the applications 204a (or 204b) inputted by a user. Additionally, the database 208 can allow the supplier or a user to access information in the query system 200 (e.g., information about the product/object, end users, and the like) which has already been previously collected and stored for new queries.

Communication among platform 202 and applications 204a and 204b can be achieved via one or more of WiFi, Cellular Radio, Bluetooth, low data rate infrastructure, direct wiring, and the like. In some implementations, one or more relay stations can allow for communication among the components of the object query system 200. In some implementations, the various components of the query system 200 can include data storage devices (e.g., memory, RAM, and the like) that can curate received/generated information.

Referring again to FIG. 1, at 104, the platform 202 determines, based on the basic search query, a target database for collecting a second set of data associated to an objective of the basic search query. As described below, the generation of the advanced search query can also be based on various data (e.g., result associated with the implementation of a previous queries associated with the target object 206a, expert data, and the like). Furthermore, the advanced search query can be generated by application of various rules (e.g., predetermined rules, rules provided by experts, and the like) on the various data.

At 106, the platform 200 receives the second set of data characterizing the determined objective from a database. At 108, the platform 200 computes, based on the second set of data, an advanced search query associated with the target object and the determined objective. At 110, the advanced search query is then provides to a search engine, which then runs a search in its normal course, and returns the results based on the advanced search query to the user.

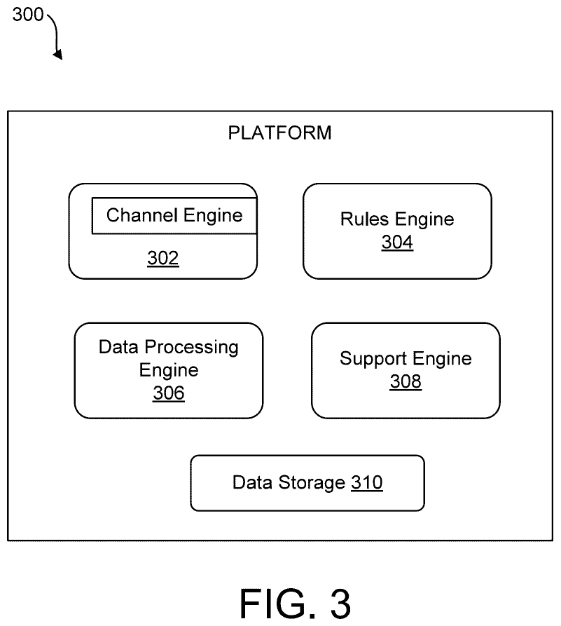

FIG. 3 illustrates an exemplary platform 300. The platform 300 can include a channel engine 302, rules engine 304, data processing engine 306, support engine 308 and data storage 310. The platform 300 can receive data from various sources (e.g., external database, experts, and the like). The channel engine 302 can generate search queries based on, for example, received data, rules generated by the rules engine 304 (and/or rules from experts). The data processing engine can process the received data (or a portion thereof) and the support engine 308 can respond to queries from the end user.

The data storage 310 can store various information associated with the target objects. For example, data storage 310 can included the lifecycle information of the target object (e.g., stage of the object, milestone of the object, action level criteria, notifications associated with the object, and the like). The data storage 310 can also include information associated with the class or group associated with the target object. The group information can include, for example, summary notice content in target objects of the group, summary notice call to action in multiple target objects in the group, and the like.

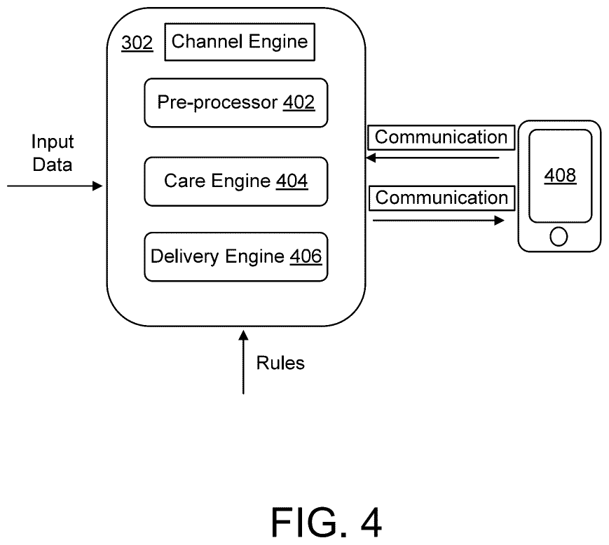

FIG. 4 illustrates an exemplary channel engine 302. The channel engine 302 can receive data from various sources (e.g., rules from the rules engine, data from data storage 310, and the like) and can generate communication channel for the target object. In some implementations, the communication channel can connect a user to third party service provider who can act to protect, preserve or better use the target object associated with the communication channel. The channel engine 302 can include a pre-processor engine 402, a care engine 404 and the delivery engine 406. The pre-processor engine 402 can process received data (e.g., data from data storage 310, and the like). In some implementations, the processing of data can be done to prepare (or analyze) the data for execution by the care/delivery engines. For example, received data can be unstructured, or only a fraction of the data may be needed to produce an actionable insight by the care and delivery engines. The pre-processor engine 402 can select the desirable sub-set of data and/or prepare the data for usage by the care/delivery engines.

In some implementations, an algorithm or rule can analyze the received data and determine communication channel characteristics (e.g., whether the communication channel should be in a text form or a video form). This determination can be on historical user response to various search queries (e.g., how often the user used previous search queries, how long the user spent engaging with the object query system, how successful the resulting care actions were, what frequency of response leads to a feeling of being nagged or neglected by the user, etc.) to determine communication channel characteristics. In some implementations, communication channel characteristics can be transmitted to the delivery engine.

The care engine 404 can receive processed data from the pre-processor 402 and can generate search queries. For example, the care engine 404 can apply rules (e.g., group rules, individual object rules, expert rules, and the like) received from the rules engine 304 and can apply those rules on the received data. Rules can be applied based on defined triggers. In some implementations, triggers can be time based, based on received data, an external event from a supplier's server, and the like. When a trigger fires, the care engine 404 can determine which rule or rules need to be executed. The execution of the rule may take place on the same server as the care engine or on a different server. The rule may or may not be provided all of the data with the trigger that is needed to execute the rule. If additional data is needed, the care engine 404 may try and get the data from a database, server, or other location. The care engine 404 can process the rule with the limited data, or may stop the execution of the rule.

The delivery engine 406 can generate parameters associated with the communication (“communication parameters”) of the search queries generated by the care engine 404. For example, the delivery engine 406 can determine the schedule for providing the communication channel to the user. In some implementations, the communication parameters can be based rules provide by a Digital Marketing Subject Matter Expert (DSME). In some implementations, the delivery engine 406 can determine additional information associated with the communication channel. For example, the delivery engine 406 can determine a schedule associated with the implementation of the communication channel (e.g., when the communication channel needs to be implemented, and the like).

In some implementations, the delivery engine 406 can include a transmission machine learning algorithm. The transmission machine learning algorithm can generate the communication parameters based on information associated with the target object (e.g., personalized information for a given target object or the user of the target object), input from DSME, and the like. The machine learning algorithm can include generating repeat or retry messages in the case of no response by the user or in the case when the user has mis-understood the previous response. In some implementations, the DSME can review and edit the communication parameters.

In some implementations, the channel engine 302 can perform multiple iterations (e.g., based on new data, new rules, trigger inputs from the end user, trigger inputs based on predetermined condition, trigger inputs from experts and the like). In some implementations, an input from the PSME can trigger the channel engine 302 (e.g., to generate communication channel). The input from the PSME can include state/milestone of the target object, conditions/limiting values associated with the various states of the target object, and the like. The channel engine 302 can include one or more of a genetic algorithm, Bayesian network, rete algorithm, inference engine, predictive model, business rule, machine learning model, neural network, classification system (e.g., random forest), regression system (e.g., least squares), and the like. In some implementations, the PSME can instruct the channel engine 302 to perform a machine learning process (e.g., based on data in data storage 310).

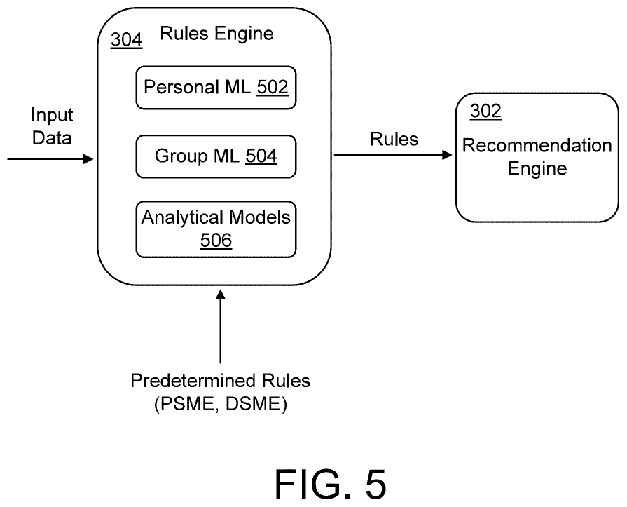

FIG. 5 illustrates an exemplary rules engine 304. The rules engine 304 can include a personal machine learning algorithm 502, a group machine learning algorithm 504 and analytical models 506. The personal machine learning algorithm 502 can generate a first set of object rules based on information associated with a given target object (e.g., personalized information for a given target object or the user of the target object) and/or macro trend information. The target object information can include one or more of data provided the by user of the target object, data associated with a result from the implementation of a previous query (e.g., from the platform 300 to the target object).

The group machine learning algorithm 504 can generate a second set of object rules based on information associated with a group (e.g., predefined group) associated with the target object. For example, the information can include macro trend information associated with the group of target objects. In some implementations, the information can include personalized information.

In some implementations, generating the first (or second) set of rules can include using predetermined analytical models and varying the properties of the analytical models (e.g., predetermined constants in the analytical model) based on the above-mentioned personalized information (or macro trend information). In some implementations, the analytical models can include previously implemented rules. Based on new information (e.g., new personalized information, new macro trend information, and the like), the previously implemented rules can be modified to generate new rules. In some implementations, the previously implemented first/second set of rules can be modified based on input rules provided by a PSME.

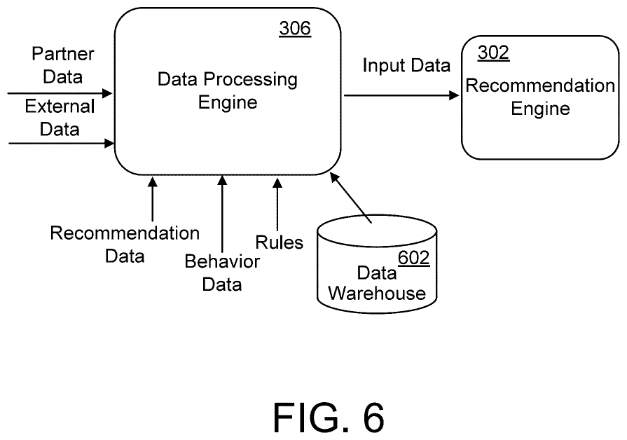

FIG. 6 illustrates an exemplary data processing engine 306. The data processing engine 306 can receive one or more of communication channel data (e.g., data characterizing result of implementation of a communication channel), external data (e.g., geographic/weather data associated with a target object), partner data (e.g., data from a partner organization), behavior data (e.g., data associated with the past behavior of the object and/or user of the object), rules (e.g., rules from rules engine 304, and the like). The data processing engine 306 can process the received data to a form that can be used by the channel engine 302. In some implementations, the data processing engine can additionally process data and/or transform the data into a form that can be used by other users and services (e.g., supplier servers, data visualization software, data analytics, market research companies, software services such as customer support systems, marketing automation systems, customer relationship management systems, ecommerce systems, content management systems, inventory management, etc.). In some implementations, the data processing engine 306 can receive data from a data warehouse 602 that can store curated data associated with the object query system.

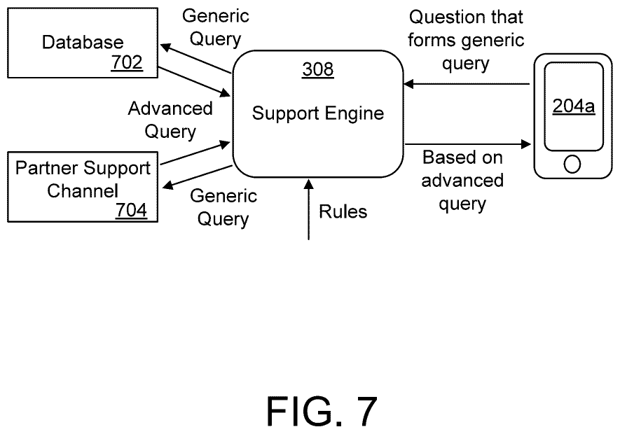

FIG. 7 illustrates an exemplary support engine 308. The support engine 308 can receive question/queries from a user of the application 204a (or 204b) executed in an operating device of the user of the object. For example, the user can ask questions related to the upkeep of the object (e.g., desirable temperature/conductivity associated with the object, precautionary steps that need to be taken in view of an impending set of external conditions, and the like). The support engine 308 can communicate with database 702 and partner support channel 704. In some implementations, the support engine can peruse through a predetermined list of question in a database and identify a match for the received question, and generate an answer based on the predetermined list of answers in the database. In some implementations, the support engine 308 can receive data from a partner support channel 704 and can retrieve the answer from the received data. In some implementations, the support engine 308 can also receive rules (e.g., from PSME, rules engine 304, and the like) and can apply the rules on existing data to determine the answer to the user question. After the answer has been determined the support engine 308 can transmit the answer to the user.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method, comprising:
receiving a first set of data characterizing a basic search query associated with a target object;
determining, based on the basic search query, a target database for collecting a second set of data associated to an objective of the basic search query;
receiving the second set of data characterizing the determined objective;
computing, based on the second set of data, an advanced search query associated with the target object and the determined objective; and
providing the advanced search query.

2. The method of claim 1, further comprising determining one or more characteristic of the advanced search query.

3. The method of claim 2, further comprising providing the determined one or more characteristics of the advanced search query.

4. The method of claim 1, wherein the second data set includes at least one of:
a user preference; or
a status of the target object.

5. A system comprising:
at least one data processor;
memory storing instructions which, when executed by the at least one data processor, causes the at least one data processor to perform operations comprising:
receiving a first set of data characterizing a basic search query associated with a target object;
determining, based on the basic search query, a target database for collecting a second set of data associated to an objective of the basic search query;
receiving the second set of data characterizing the determined objective;
computing, based on the second set of data, an advanced search query associated with the target object and the determined objective; and
providing the advanced search query.

6. The system of claim 5, further comprising determining one or more characteristic of the advanced search query.

7. The system of claim 6, further comprising providing the determined one or more characteristics of the advanced search query.

8. The system of claim 5, wherein the determined characteristic is at least one of:
a user preference; or
a status of the target object.

9. A non-transitory computer readable medium storing instructions, which when executed by at least one data processor of at least on computing system, causes the at least one data processor to perform operations comprising:
receiving a first set of data characterizing a basic search query associated with a target object;
determining, based on the basic search query, a target database for collecting a second set of data associated to an objective of the basic search query;
receiving the second set of data characterizing the determined objective;
computing, based on the second set of data, an advanced search query associated with the target object and the determined objective; and
providing the advanced search query.

10. The non-transitory computer readable medium of claim 9, further comprising determining one or more characteristic of the advanced search query.

11. The non-transitory computer readable medium of claim 10, further comprising providing the determined one or more characteristics of the advanced search query.

12. The non-transitory computer readable medium of claim 9, wherein the determined characteristic is at least one of:
a user preference; or
a status of the target object.
